(19) United States
(12) Patent Application Publication
(10) Pub. No.: US 2005/0259710 A1
(43) Pub. Date: Nov. 24, 2005

(54) Grooved crucible ceramic clay

(76) Inventors: Hriton Arakelian, Sun Valley, CA (US); Roubin Artin, Granada Hills, CA (US)

Correspondence Address: HRITON ARAKELIAN, 13139 SCHOEN BORN ST, SUN VALLEY, CA, 91352, US

(21) Appl. No.: 10/358,470

(22) Filed: May 22, 2004

(51) Int. Cl. F27D 1/00

(52) U.S. Cl. 373/72

(57) ABSTRACT

The nature of the technical disclosures of my invention is simple and unique. A ¼×0.0381 inches groove around a ceramic clay crucible is simple to adapt. I invented a mold which has the feature of ¼×0.0381 inches groove around, to make the casting of a grooved ceramic clay crucible feasible. This is new in the art of casting because the ceramic clay crucibles used in Goldsmith industry do not have a groove around them. The purpose of the groove is to enable anyone who is working in casting precious metals under excessive heat to handle the crucible which is used in the process more efficiently and securely. This groove would certainly improve the melting and casting procedures simply because the strap around the newly grooved crucible would be firmly fastened, thus preventing any spills, and at the same time protecting the worker.

### BACKGROUND OF INVENTION

1. Field of Invention

Technically eliminates the hazards of spilling hot precious melted metals. Thus giving protection and safety to the one who is handling the molding procedure and at the same time preserving precious melted metals directly in the mold “no waste”.

2. Background Art

Goldsmith industries which include molding had been much the same over the decades. Safety first and spilling precious melted metals are my concerns.

My invention is to solve these problems which are facing those who work in the industry.

### BRIEF SUMMARY OF THE INVENTION

The advantages of the invention are:

1. Safety procedures are my primary concerns.

2. Not wasting precious melted metals when put in a mold.

3. Proper handling of the whole process.

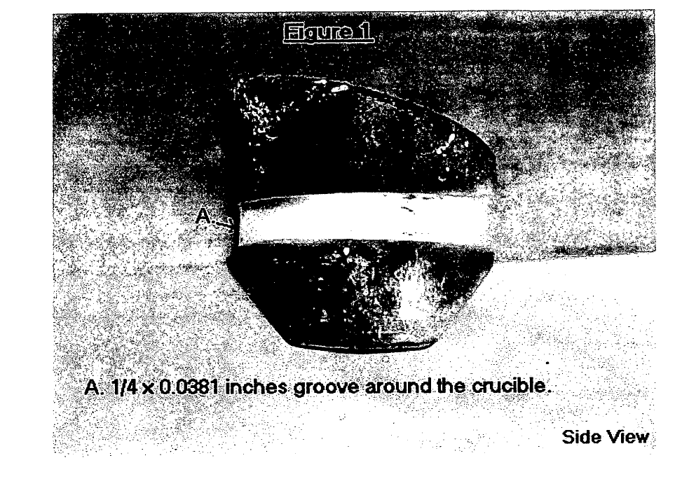

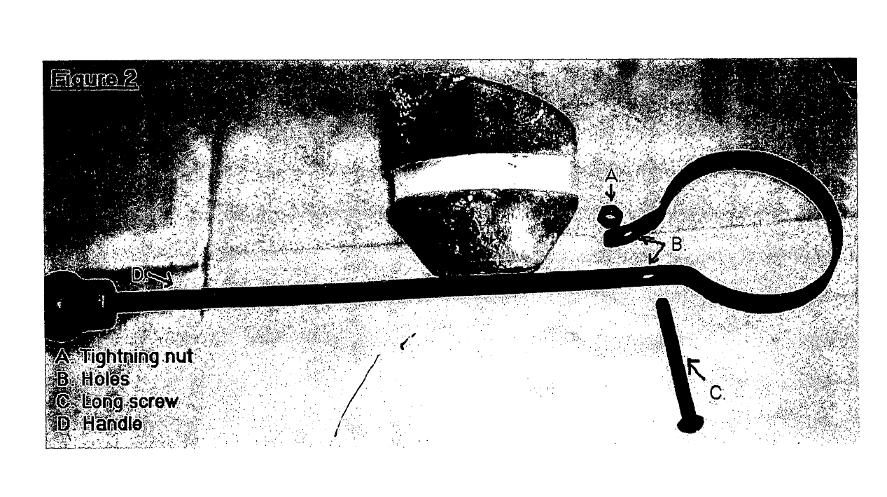

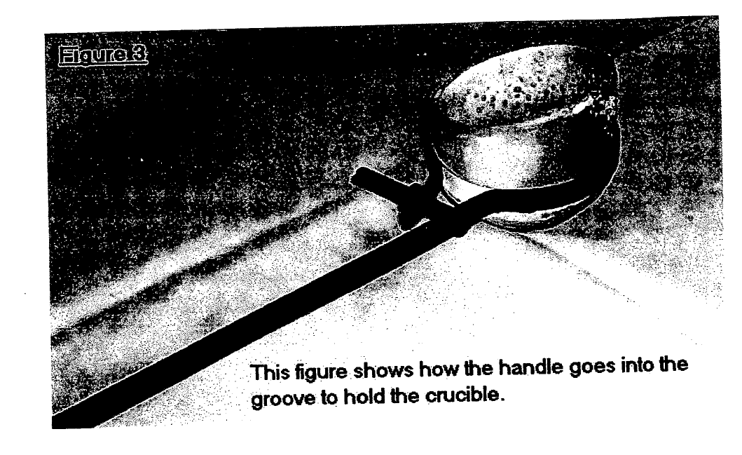

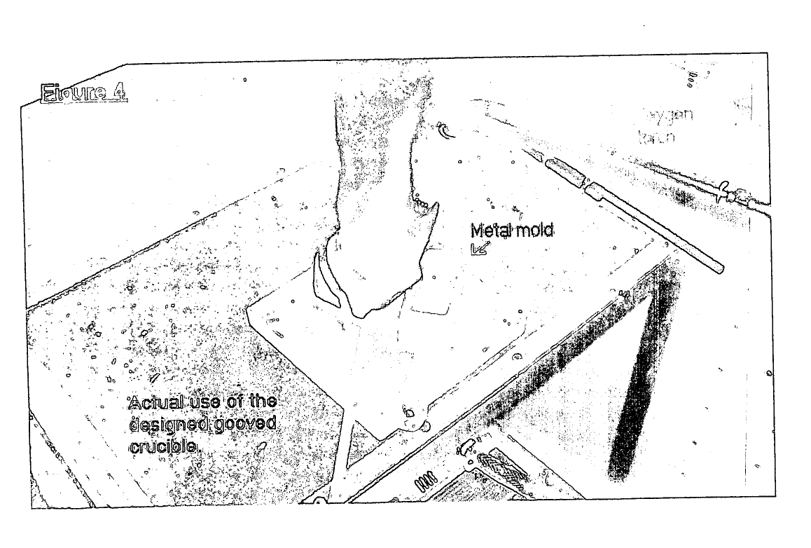

Brief description of the several views of the figures; listing of all figures by numbers (e.g. FIG. 1A) and with corresponding statements explaining what each figure depicts.
1. FIG. 1—A side view of a grooved crucible.
2. FIG. 2—Shows how the strap is fastened firmly around the groove of the crucible.
3. FIG. 3—Illustration of the invention.
4. FIG. 4—Application of the invention.

### DETAILED DESCRIPTION OF THE INVENTION

A ceramic clay crucible is used in the molding process of melting precious metals, when excessive heat is directed at the metal by an oxygen gas torch, it is usually held by a strap around the crucible which in turn may slip “no matter how tightened it is”, mainly because of the excessive heat and consequently might fall and cause damage to the person who is handling it and at the same time spill the melted precious metals all over.

To this end, my invention is to make a ¼×0.0381 inches groove around the crucible (see FIG. 1A). Which will hold the strap around the crucible firmly, safely and properly, and make the molding procedure safe.

1. A designed Groove for holding a strap around a ceramic clay crucible.
